(19) United States
(12) Patent Application Publication
(10) Pub. No.: US 2016/0368132 A1
(43) Pub. Date: Dec. 22, 2016

(54) Sawhorse Support Assembly and Method

(71) Applicant: James Carroll, Montrose, CO (US)

(72) Inventor: James Carroll, Montrose, CO (US)

(21) Appl. No.: 15/185,842

(22) Filed: Jun. 17, 2016

Related U.S. Application Data
(60) Provisional application No. 62/181,994, filed on Jun. 19, 2015.

(51) Int. Cl. B25H 1/06; B25B 5/10; B25B 5/16

(52) U.S. Cl. CPC B25H 1/06; B25B 5/163; B25B 5/10

(57) ABSTRACT

An exemplary embodiment providing one or more improvements includes a sawhorse support assembly apparatus and methods in which the support assembly can be manufactured and used for supporting a beam for creating a sawhorse.

### RELATED APPLICATIONS

The present application claims priority from U.S. Provisional Application Ser. No. 62/181,994, filed on Jun. 19, 2015 which is incorporated herein by reference.

### BACKGROUND

The present invention is related to a sawhorse support assembly and, more particularly, to apparatus, system and methods for reversibly connecting the support assembly to a beam and supporting the beam in a generally horizontal orientation for serving as a sawhorse.

The sawhorse support assemblies are configured such that two or more support assemblies can be quickly connected to a single beam to produce a sawhorse. The sawhorse support assemblies can be lightweight and can be used indoors or outdoors. The sawhorse support assemblies produce strong and robust sawhorses that are durable and long-lasting. The support assemblies can be used with beams of common construction material of multiple different sizes. When not in use, the support assemblies can be quickly removed from the beam and are relatively lightweight and small for easy storage.

The sawhorse support assemblies do not depend on the force of the legs moving away from one another to hold the beam like a previous sawhorse hardware. Such previous hardware can change the height of the beam depending on how far apart the legs are positioned and the height and holding capacity can depend on the thickness of the beam.

The foregoing examples of the related art and limitations related therewith are intended to be illustrative and not exclusive. Other limitations of the related art will become apparent to those of skill in the art upon reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

In general, a sawhorse support assembly and method are described for use with a beam to create a sawhorse. The sawhorse support assembly for operating at least in a pair in which each support assembly supports a portion of a beam above a floor. The sawhorse beam having an elongated length extending between two ends, and lower, upper, and side surfaces which extend along the length of the beam. The sawhorse support assembly comprising first and second legs and a beam connector for connecting the sawhorse support assembly to the beam. The beam connector is connected to the first and second legs such that the legs cooperate to support the beam connector above the floor when the beam connector is connected to the beam. The beam connector includes a beam support for contacting the lower surface of the beam to resist movement of the beam toward the floor when the sawhorse support assembly is connected to the beam. The beam connector also including an upright segment connected to the beam support and arranged for contacting one of the side surfaces of the beam. The beam connector also including a clamping mechanism connected to the beam support and configured for applying a compressive force to the other one of the side surfaces of the beam to hold the beam in a fixed position relative to the sawhorse support assembly when the beam connector is connected to the beam. The clamping mechanism includes a clamping plate, a clamping plate actuator connected to the clamping plate, and an actuator support configured for supporting the clamping plate actuator and connected to the beam support. The clamping mechanism is configured for selective movement of the clamping plate by the clamping plate actuator through a range of positions relative to the upright segment. Then range of positions including positions which allow the beam to be placed between the clamping plate and the upright segment, and positions which subject the beam to compression when the beam is between the clamping plate and the upright segment and which secure the sawhorse support assembly to the beam when the lower surface of the beam is supported by the beam support.

A method is disclosed for manufacturing a sawhorse support assembly that is connectable to a sawhorse beam to support one portion of the beam above a floor. A beam support is configured for contacting a lower surface of the beam to resist movement of the beam toward the floor when the sawhorse support assembly is connected to the beam. First and second legs are arranged and the legs are connected to the beam support such that the beam support is positioned above the floor by the legs when the sawhorse support assembly is connected to the beam. An upright segment is configured for contacting a first side surface of the beam. A clamping mechanism is arranged for applying a compressive force to a second side surface of the beam, on an opposite side of the beam from the first side surface, to hold the beam between the clamping mechanism and the upright segment in a fixed position relative to the sawhorse support assembly when the beam connector is connected to the beam.

A sawhorse support assembly is also disclosed for operating in at least a pair to support a beam at a working height above a floor. The support assembly includes first and second legs and a beam support with an upper surface for contacting a lower surface of the beam and a lower surface, opposite to the upper surface, to which the first and second legs are connected. The support assembly also includes an upright segment that is connected to the beam support such that an angle of at least approximately 90 degrees is defined in a corner between the upright segment and the upper surface of the beam support. An actuator support is included that is connected to the beam support and a clamping plate actuator is connected to the actuator support and is configured for selective movement relative to the actuator support. A clamping plate is connected to the clamping plate actuator, and the clamping plate actuator is configured to move the clamping plate through a range of positions relative to the upright segment. The range of positions including at least one position which allows the beam to be placed between the clamping plate and the upright segment to contact the upper surface of the beam support, and at least one position which subjects the beam to compression when the beam is between the clamping plate and the upright segment and which secures the support assembly to the beam when the lower surface of the beam is in contact with the upper surface of the beam support.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a perspective view illustration of two support assemblies connected to a beam to create a sawhorse.

FIG. 2 is an elevation view illustration of one of the support assemblies shown in FIG. 1.

FIG. 3 is an enlarged partial illustration of a beam connector portion of the support assembly of FIG. 2.

FIG. 4 is another enlarged partial illustration of the beam connector portion of FIG. 3

FIG. 5 is another enlarged partial illustration of the beam connector portion of FIGS. 3 and 4.

FIG. 6 is a perspective view of the beam connector portion of the support assembly.

FIG. 7 is an illustration of a side elevation of the beam connector of the support assembly.

FIG. 8 is an enlarged partial illustration of a beam connector portion of a support assembly having an angled linear actuator.

FIG. 9 is a perspective view of a beam connector portion of a support assembly having multiple linear actuators.

FIG. 10 is a diagram of a method for manufacturing a sawhorse support assembly.

### DETAILED DESCRIPTION

The following description is presented to enable one of ordinary skill in the art to make and use the invention and is provided in the context of a patent application and its requirements. Various modifications to the described embodiments will be readily apparent to those skilled in the art and the principles taught herein may be applied to other embodiments. Thus, the present invention is not intended to be limited to the embodiments shown, but is to be accorded the widest scope consistent with the principles and features described herein including modifications and equivalents. It is noted that the drawings are not to scale and are diagrammatic in nature in a way that is thought to best illustrate features of interest. Descriptive terminology may be adopted for purposes of enhancing the reader's understanding, with respect to the various views provided in the Figures, and is in no way intended as being limiting.

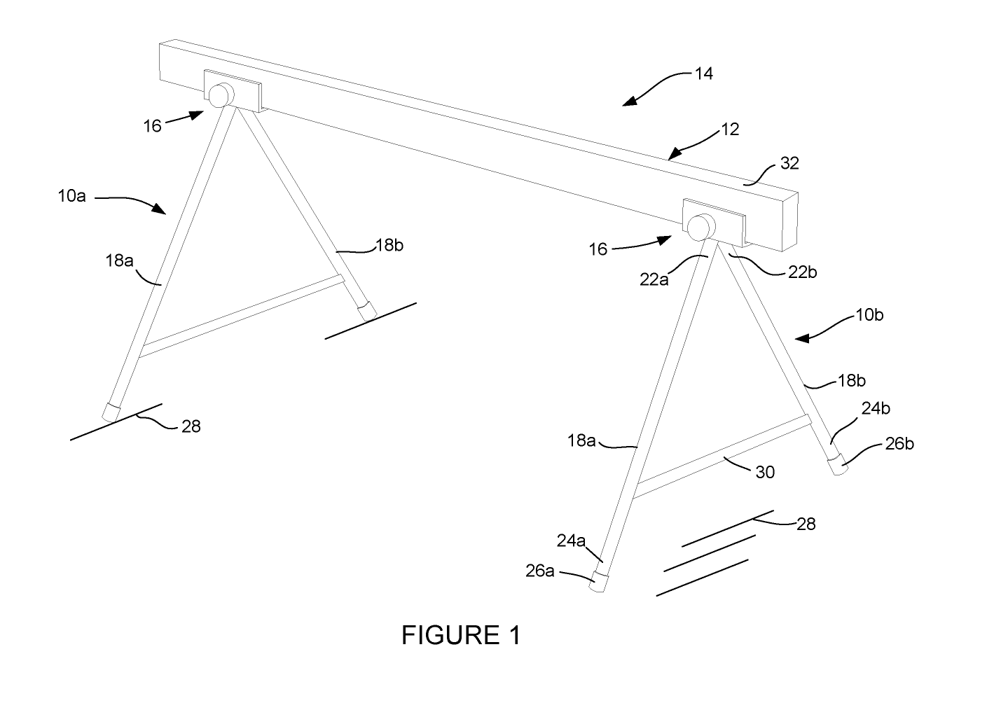

Attention is now directed to the Figures wherein like items may refer to like components throughout the various views. FIG. 1 is a perspective view illustration of two support assemblies 10a and 10b connected to a beam 12 to create a sawhorse 14. Support assemblies 10a and 10b are essentially the same as one another and are interchangeable. Support assembly 10a can be connected to beam 12 where support assembly 10b is positioned and support assembly 10b can be connected to beam 12 where support assembly 10a is positioned. The support assemblies can also be positioned at different places on the beam. Each of the support assemblies operate to support a portion of the beam. Although at least two support assemblies are used to create a sawhorse, for the sake of clarity, the features of a single support assembly will be discussed. Support assembly 10 includes a beam connector 16 for quickly and securely attaching the support assembly to the beam.

Support assembly 10 also includes legs 18a and 18b which are attached to the beam connector at upper leg ends 22a and 22b, and which extend to lower leg ends 24a and 24b. The lower leg ends are arranged to contact the ground, floor or other surface, generically referred to as floor 28, on which the sawhorse can be placed. The lower leg ends can have protective feet 26a and 26b which can be made from rubber or other material which can protect the surface under the sawhorse from damage from the legs. The legs can be made from a strong material such as steel or aluminum, they can be tubular and have a round, square, rectangular or other shaped cross section. The legs can be welded, bolted or otherwise permanently or removably connected to the beam connector. In an embodiment, the legs are tubular galvanized steel with a one-inch cross section and are welded to the beam connector. The legs can be made from single piece of stock which can be bent to form the two legs and to have a portion that is connected to the beam connector.

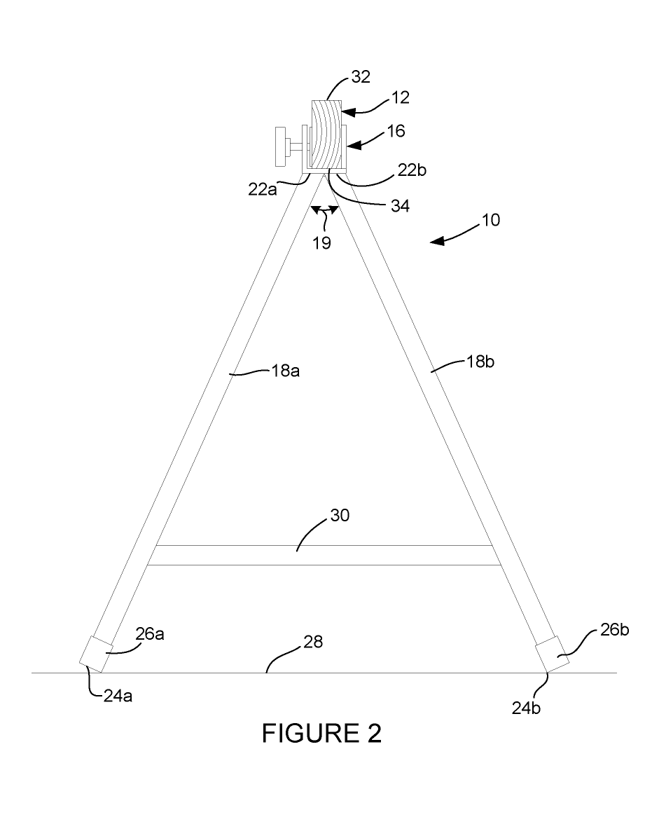

Referring now to FIG. 2, legs 18a and 18b can be arranged at an angle 19 relative to one another such that lower leg ends are at a spaced apart relationship sufficient to resist tipping of the sawhorse in a direction perpendicular to the length of the beam. In an embodiment, the lower leg ends 24a and 24b can be approximately 24 inches apart. The leg ends can be closer or further apart from one another so long as they produce a sufficient resistance to tipping. The legs can be connected to one another with a cross member 30. The cross member can be connected to the legs and arranged to resist forces tending to move the lower leg ends away from one another, such as can be produced when a load is introduced to an upper surface 32 of the beam. The legs can be produced to have a length which places the upper surface of the beam at a working height, relative to the floor 28, for a sawhorse user. In an embodiment, the legs can be sized to place a bottom surface 34 of the beam at approximately 25-½ inches above the floor, which places the working height at the top of a 2×4 beam at approximately 29 inches above the floor and at the top of a 2×6 beam at approximately 31 inches above the floor. Other leg lengths can be used which can place the working height at the top of the beam at a lower or higher height and the leg length, cross section, and material strength can be coordinated with the type and size of beam, or range of beam types and sizes to be used. Relatively larger and stronger legs can be used for relatively larger or stronger beams and relatively smaller and lighter legs can be used for beams which will be used to carry smaller loads. The cross member and the legs can have pivot points to allow the support assembly legs to be folded up against one another and the legs can be configured to be telescoping for length adjustment.

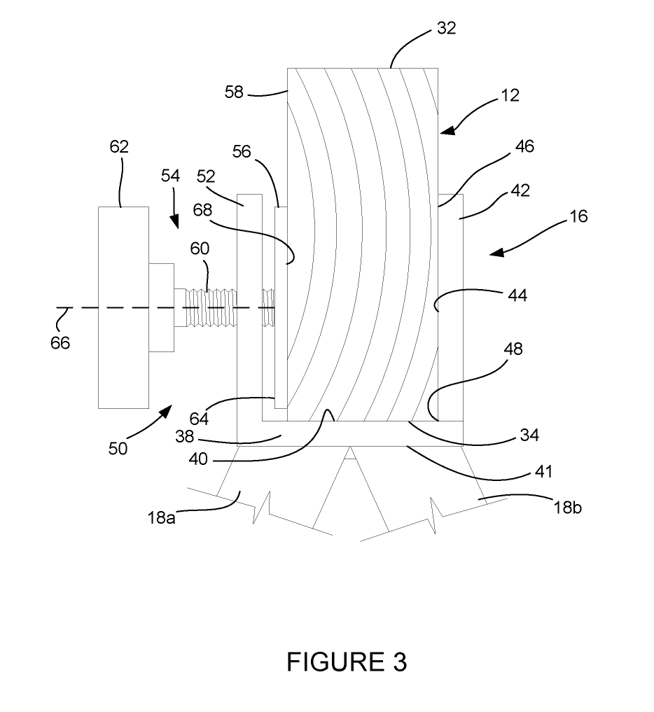

Referring now to FIG. 3, an enlarged elevation view of beam connector 16 is shown connected to beam 12. The beam connector can have a beam support 38 that has an upper surface 40 for contacting the lower surface 34 of the beam to resist movement of the beam toward the floor and a lower surface 41 to which the legs can be connected. The beam connector can also have an upright segment 42 having an inner facing surface 44 for contacting a side 46 of beam 12. The upper surface 40 and inner facing surface 44 can define a corner 48 which can have an angle of essentially 90 degrees so that a beam having perpendicular adjacent sides can be engaged by these two surfaces of the beam connector.

The beam connector also includes a clamping mechanism 50 for securely holding the beam in the beam connector. The clamping mechanism can include an actuator support 52 which can be connected to the beam support 38 and which supports a clamping plate actuator54. The clamping plate actuator can selectively move a clamping plate 56 toward and away from a side 58 of the beam when the beam is in the beam connector. In the embodiment shown in FIG. 3, the clamping plate actuator can include a threaded longitudinal section 60 which extends between a head 62 and an outer surface 64 of the clamping plate 56 where the longitudinal section is connected to the clamping plate. The actuator 54 can be rotated about a longitudinal axis 66 of the threaded longitudinal section to move the clamping plate such that an inner surface 68 of the clamping plate is forced against the beam side 58. The clamping mechanism can apply a compressive force against the beam sides between the upright segment and the clamping plate to hold the beam in a fixed position relative to the sawhorse support assembly when the beam connector is connected to the beam.

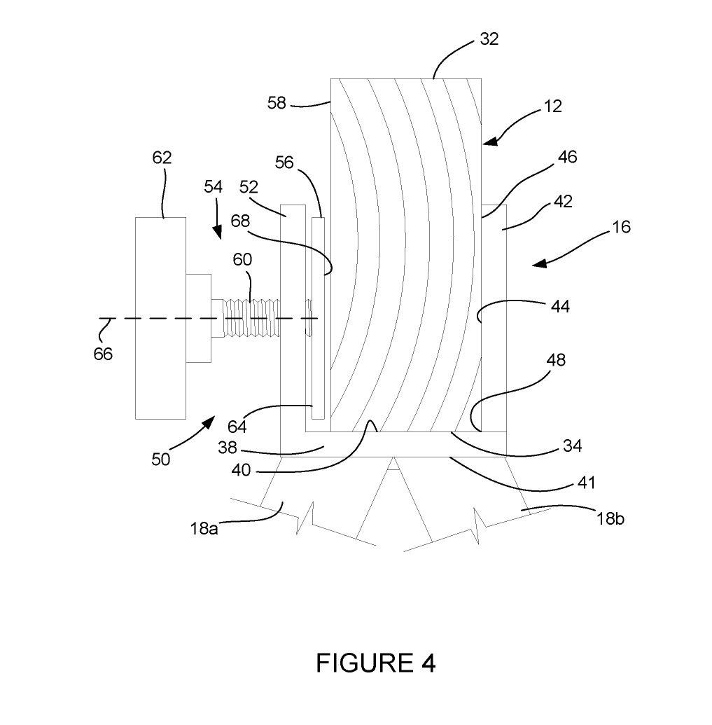

Referring now to FIG. 4, an enlarged elevation view of beam connector 16 is shown relative to beam 12. In an embodiment of the beam connector 16 of the sawhorse support assembly shown in FIG. 4, the clamping plate 56 is moved relatively away from the upright segment and is not in contact with the beam. In this position the beam can be placed between the clamping plate and the upright segment and can be moved into contact with the beam support 38. The clamping plate can then be moved against the beam side to secure the beam to the support assembly.

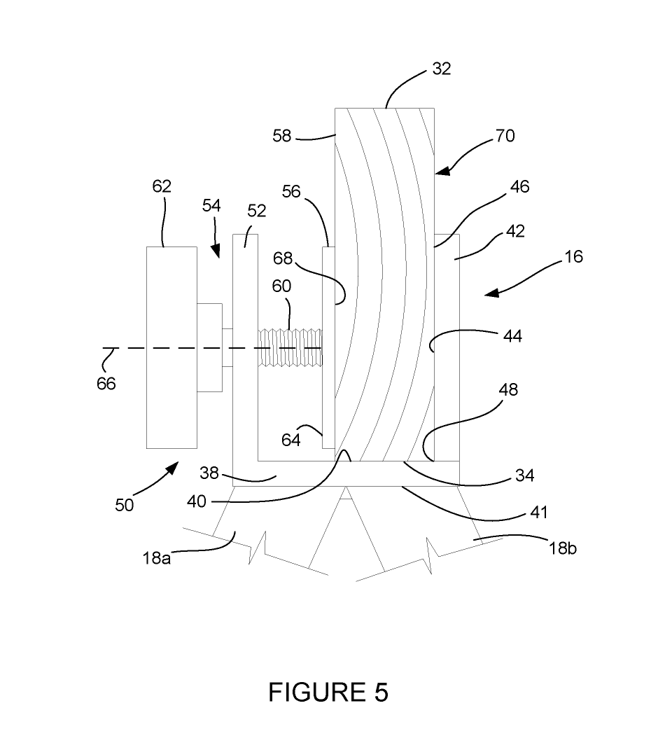

Referring now to FIG. 5, an enlarged elevation view of the beam connector 16 is shown securing the support assembly to a relatively smaller beam 70. FIGS. 3, 4 and 5 illustrate that the clamping plate can be configured to move through a range of positions including positions in which allow beams to be placed between the clamping plate and the upright segment and positions which subject beams of one or more sizes to compression when the beams are between the clamping plate and the upright segment.

In an embodiment, the beam support 38 can be about 1-¾ inches across between the actuator support 52 and the upright segment 42 which can allow room for the clamping plate and a 1-½ inch cross sectional width of a typical two-by dimensional lumber beam between the upright segments. The actuator support and upright segment can be spaced closer or further apart from one another to allow larger or smaller beams and/or clamping plates. The upright segment can be 2-¼ inches high or can be shorter or taller than 2-¼ inches high and the upright segment can be a different height from the actuator support. A relatively shorter upright segment 42 can provide less resistance to clockwise beam rotation (from the perspective shown in FIG. 3) about a beam longitudinal axis and a relatively longer upright segment 42 can provide more resistance to the clockwise beam rotation about the beam longitudinal axis.

One or both of the actuator support and upright segment can be the same dimension as the beam side face 54, or can be smaller than the beam side face such that the beam extends above the upright segments as is shown in FIGS. 3, 4 and 5. Having the beam extend above the upright segments allows users to saw through wood products supported by the sawhorses without having the saw blade contact the upright segments even if the saw blade cuts into the top of the beam.

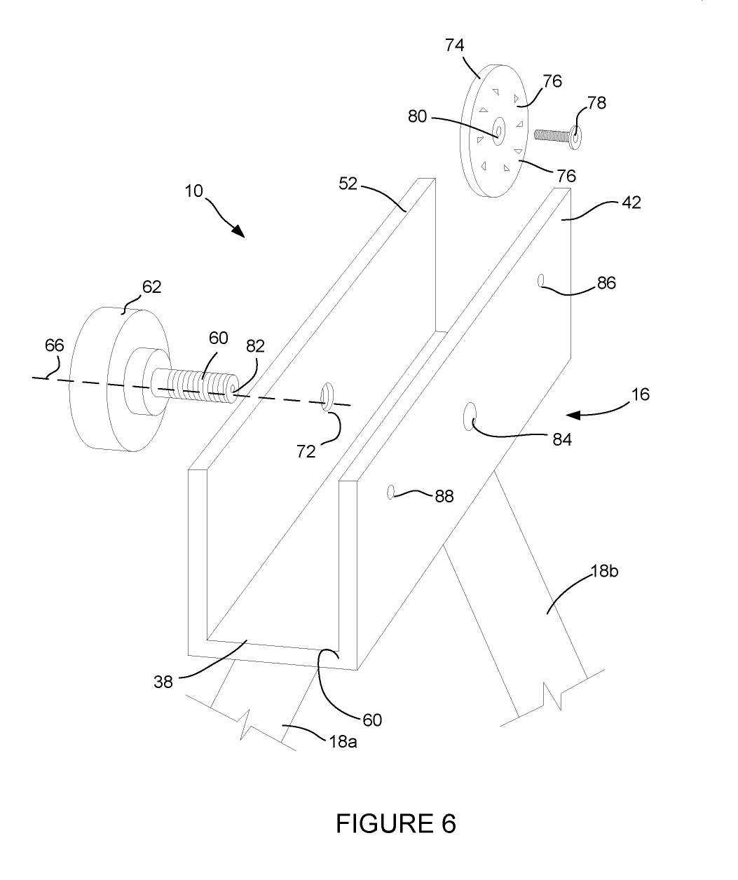

Actuator support 52 can define a threaded hole 72 (see FIG. 6) which can receive the threaded longitudinal section 60 such that rotational movement of the head moves clamping plate 56 toward and away from the side face of the beam. In an embodiment, a threaded nut can be attached to actuator support 52 instead of, or in addition to, the threaded hole for receiving the threaded longitudinal section. The threaded nut can be used, as an example, when the actuator support is made of a material that is not thick enough for useful threads. In an embodiment, the threaded hole or nut can be ⅜ inch, however the threaded hole and threaded longitudinal section can be smaller or larger and can have course or fine threads which can be metric or standard. The actuator support can be large enough to support the actuator by define the hole for the clamping plate actuator as long as it is strong enough to resist the compression of the clamping plate against the beam.

The beam connector can be configured such that the clamping plate is relatively closer or farther from the beam support 46. From the perspective shown in FIG. 3, positioning the clamping plate relatively farther above the lower beam support can make the beam connector more resistive to counterclockwise rotation of the beam about the beam longitudinal axis; and positioning the clamping plate relative closer to the beam support can make the beam connector less resistive to counterclockwise rotation of the beam about the beam longitudinal axis and more resistive to clockwise rotation of the beam about the beam longitudinal axis.

In an embodiment in which threaded longitudinal section 42 has standard right hand threads, turning the head 62 clockwise (when facing toward the side of the beam connector having the head) causes the clamping plate to be forced against side face 58 and side face 46 of the beam contacts the upright segment 42 and the beam is securely held between the clamping plate and the upright segment in the beam connector 16. The lower surface 34 of the beam can be positioned on top of the beam support 38 and the beam can be firmly held in the corner 48 between the beam support and the upright segment to resist longitudinal movement of the beam as is discussed in more detail below.

Head 62 can be a fluted knob, torque knob, bar knob, lever knob, lobed knob, spinner knob, ball knob, arm knob or other type of knob. The head can also be another type of handle such as a double or single handle and the threaded longitudinal section can have a hole that is perpendicular of the threaded longitudinal section axis and through which a screwdriver can be inserted to turn the threaded longitudinal section. The head can also be a head of a bolt or screw to which a tool can engage to provide leverage for rotating the threaded longitudinal section to move the clamping plate toward and away from a side face of the beam.

Referring now to FIG. 6, a perspective view illustration is shown of an embodiment of beam connector 16 in which the clamping plate, head and threaded longitudinal section are not assembled. Clamping plate 74 can be circularly shaped and can include a number of teeth 76 which can penetrate into the side of the beam, when the beam is clamped into the beam connector, to provide a holding force in addition to the friction of the clamping plate against the beam. Clamping plate 74 can be attached to threaded longitudinal section 60 using a bolt or screw 78 which can extend through a hole 80 in the clamping plate and can be screwed into a hole 82 in the end of the threaded longitudinal section 60. Upright segment 42 can define a hole 84 through which a tool (not shown) can be inserted to secure screw 78 in hole 82 during assembly of support assembly 10. Clamping plate 74 can also be attached to the threaded longitudinal section by using a ball and socket or other arrangement which allows the threaded longitudinal section to rotate relative to the clamping plate.

Upright segment 42 can also define one or more holes 86 through which screws, lag-bolts or other hardware can be screwed into the side of the beam to provide additional holding strength to secure the beam to the support assembly. Beam support 38, clamping plate 74 and upright segment 42 cooperate to resist movement of the beam along the longitudinal axis of the beam relative to the support assembly. Placing the beam firmly against the lower beam support while tightening the clamping mechanism forces the beam into corner 48 between the upright segment 42 and the beam support 38.

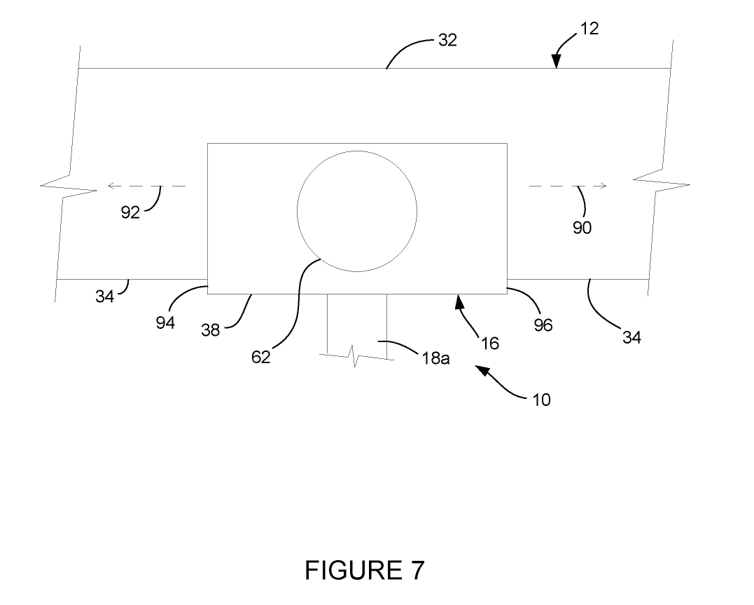

Referring now to FIG. 7, an illustration of a partial side elevation of the support assembly is shown. Longitudinal forces along the long axis of beam 12 of the sawhorse, represented by dashed arrows 90 and 92, tend toward pivoting the support assembly about the clamping plate. If not sufficiently resisted, this pivoting motion would move the lower leg ends in an arcuate motion toward the beam and would cause the sawhorse to collapse. Force in the direction of arrow 90 produces a relative rotational force of the support assembly in a clockwise direction and forces a first end 94 of beam support 38 relatively toward lower surface 34 of beam 12; and forces a second end 96 of beam support 38 relatively away from the lower surface of the beam. Longitudinal force in the direction of arrow 92 produces a relative rotational force of the support assembly in a counter-clockwise direction and forces first end 94 of beam support 38 relatively away from lower surface 34 of beam 12; and forces second end 96 of beam support 38 relatively toward the lower surface of the beam. Longitudinal force in either direction also attempts to move the clamping plate closer to the lower surface of the beam by dragging the clamping plate along the surface of the beam. In either direction, the legs 18 act as a lever and the end of the lower beam support being forced toward the bottom of the beam acts as a fulcrum against the clamping plate.

The actuator support and upright segment, and beam support can have the same length as one another in the direction of the beam length or can have different lengths. Support assemblies having an upright segment with a 5 inch length have proven to produce a sturdy sawhorse with two-by dimensional lumber that resists longitudinal movement of the beam. Longer lower beam supports can also be used as they will allow the legs to have less leverage against the clamping plate. Also shorter lower beam supports may also be used so long as sufficient resistance to beam longitudinal movement is provided.

Support assembly 10 can be configured to be used with specific sizes of beams or configured to be used with ranges of different beam sizes. The beam connector can be configured for standard dimensional lumber thickness, which is commonly referred to as two-by and has an actual thickness of approximately 1-½ inches. Two-by dimensional lumber is a common building material and comes in several standard widths, such as: two-by-four (1-½″×3-½″); two-by-six (1-½″×5-½″); two-by-eight (1-½″×7-½″); two-by-ten (1-½″×9-½″); and two-by-twelve (1-½″×11-½″). Any of these dimensional lumber boards can be used as beams with support assemblies that are configured for 1-½ inch thick material. Using lumber that has a larger width can raise the upper surface of the beam and therefore the height of the sawhorse relative to smaller width lumber and larger width lumber increases the strength of the sawhorse as well. Dimensional lumber also comes in many standard lengths and the support assemblies can accommodate all standard length boards and cut-off length boards using two or more support assemblies to create a sawhorse. Beam connector 16 can also be configured to be used with thinner one-by lumber that is approximately ¾ inches thick. The beam connector can be configured to use thicker materials such as laminated veneer lumber (LVL) which can be 1-¾ inches thick or more, glu-lam beams, finger jointed beams and even wood I-joists. The beam connector can be configured to use beams having a range of thickness so that a specific thickness of lumber does not have to be obtained. For example, the beam connector can be configured to use beams in a range from ¾ inches to 1-¾ inches thick to accommodate one-by lumber, two-by lumber, and LVL beams by using a threaded longitudinal section that is long enough to force the clamping plate against a ¾ inch thick beam while having the upright segments spaced far enough from one another to accommodate the LVL beam. The support assembly can also be used with weather resistant pressure treated lumber and the lumber can be re-used or re-purposed after use with the support assemblies.

Although the clamping mechanisms of support assemblies 10a and 10b are shown on the same side of the beam in FIG. 1, it should be noted that the clamping mechanisms can be connected on the opposite side of the beam from the position shown in FIG. 1, and can be connected on opposite sides of the beam from one another.

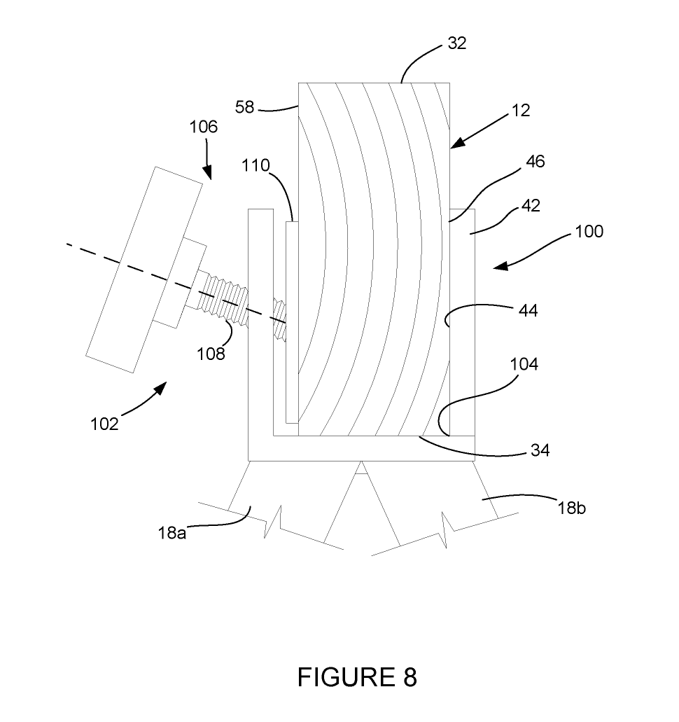

Referring now to FIG. 8, a beam connector 100 can have one or more clamping mechanisms 102 that are configured to force the beam into a corner 104. A linear actuator 106 can include a threaded longitudinal section 108 which can be angled down toward the corner such that a compressive force applied to a clamping plate 110 by the linear actuator pushes the beam toward the corner, In this embodiment, movement of the clamping plate by the linear actuator selectively moves the clamping plate relatively away from the upright segment and beam support for insertion of the beam, and relatively closer to the upright segment and beam support to subject the beam to compression. The angle of the linear actuator can force the clamping plate directly at the corner or either more toward the beam support or the upright segment.

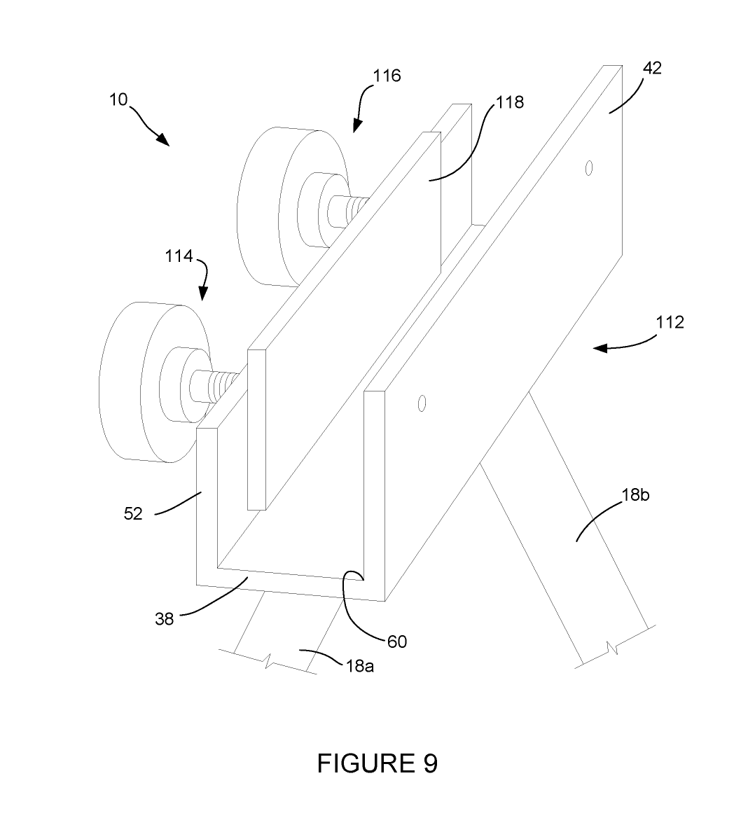

In another embodiment, shown in FIG. 9, a beam connector 112 can have multiple linear actuators 114 and 116 that are spaced from one another along the length of the beam when the beam is attached. Multiple threaded longitudinal segments can be connected to a single clamping plate 118 or multiple clamping plates. The clamping plate can have a generally round shape, such as is shown in FIG. 6, or can have another shape, such as square or rectangular, for instance. This configuration can be beneficial to resist longitudinal movement of the beam since such movement would have to move the clamping plates along the surface of the beam in different directions and there is not a single pivot point around which the support assembly can rotate.

The upright segment 50 can include teeth or other texture to contact the side of the beam and to help resist movement of the beam relative to the support assembly. The support assembly can be configured to position the beam centered over the legs and each support assembly can have more than one beam connector.

In an embodiment, the beam connector can be manufactured by bending a single piece of sheet metal into the necessary shape for the lower beam support and upright segments. A hole can be punched in one of the upright segments and a nut can be welded over the hole. The head can be attached to the threaded longitudinal section which can be screwed through the nut before the clamping plate is attached. The legs can be formed from a single length of steel tubing by bending the tubing at a point to define the upper leg ends which can then be welded to the beam connector. The cross member can be welded between the legs and the protective feet can be installed on the lower leg ends. The support assembly can be painted or otherwise coated to protect the material.

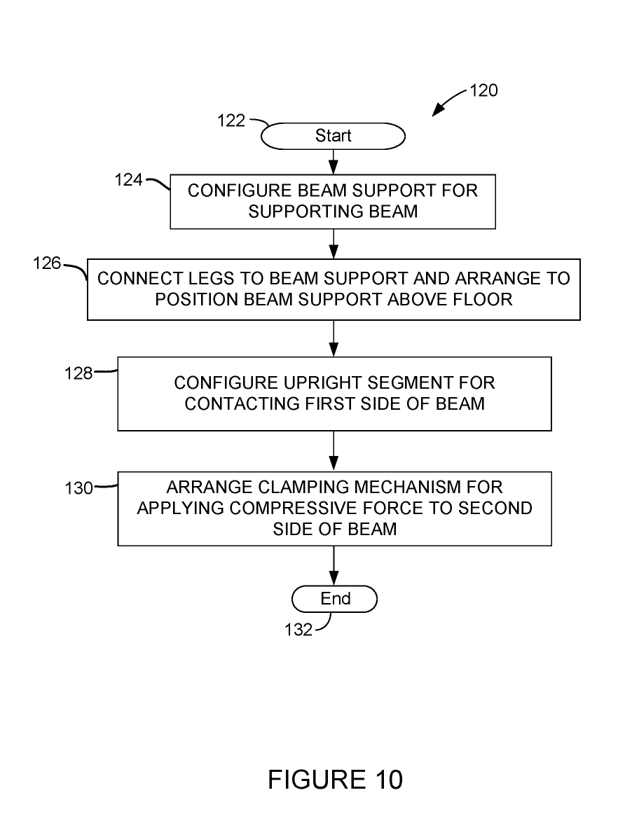

A method for manufacturing a sawhorse support assembly 120 is shown in FIG. 10 and begins at a start 122. Method 120 then proceeds to 124 where a beam support is configured for contacting a lower surface of a beam to resist movement of the beam toward a floor when the sawhorse support assembly is connected to the beam. Method 120 then proceeds to 126 where first and second legs are arranged and connected to the beam support such that the beam support is positioned above the floor by the legs when the sawhorse support assembly is connected to the beam. Method 120 the proceeds to 128 where an upright segment is configured for contacting a first side surface of the beam. Method 120 then proceeds to 130 where a clamping mechanism is arranged for applying a compressive force to a second side surface of the beam to hold the beam between the clamping mechanism and the upright segment in a fixed position relative to the sawhorse assembly when the beam connector is connected to the beam. Method 120 then proceeds to 132 where the method ends. It should be noted that the method steps described above do not have to be performed in the order that they are listed.

A sawhorse can be quickly assembled by placing a support assembly under a beam such that the lower surface of the beam is flat on the lower beam support of the beam connector. The head can then be turned until the beam is tightly secured between the clamping plate and the upright segment on the opposite side of the beam from the clamping plate. Another support assembly is similarly connected to the beam at some distance from the other support assembly and the sawhorse is complete and ready for use. To disassemble the sawhorse, the heads are turned to release the pressure of the clamping plates against the beam and the beam is taken out of the beam connectors.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A sawhorse support assembly for operating at least in a pair in which each support assembly supports a portion of a beam above a floor, the beam having an elongated length extending between two ends, and lower, upper, and side surfaces which extend along the length of the beam, the sawhorse support assembly comprising:
first and second legs;
a beam connector for connecting the sawhorse support assembly to the beam, the beam connector connected to the first and second legs such that the legs cooperate to support the beam connector above the floor when the beam connector is connected to the beam, the beam connector including:
a beam support for contacting the lower surface of the beam to resist movement of the beam toward the floor when the sawhorse support assembly is connected to the beam;
an upright segment connected to the beam support and arranged for contacting one of the side surfaces of the beam; and
a clamping mechanism connected to the beam support and configured for applying a compressive force to the other one of the side surfaces of the beam to hold the beam in a fixed position relative to the sawhorse support assembly when the beam connector is connected to the beam, the clamping mechanism including:
a clamping plate;
a clamping plate actuator connected to the clamping plate; and
an actuator support configured for supporting the clamping plate actuator and connected to the beam support, and wherein the clamping mechanism is configured for selective movement of the clamping plate by the clamping plate actuator through a range of positions relative to the upright segment including positions which allow the beam to be placed between the clamping plate and the upright segment, and positions which subject the beam to compression when the beam is between the clamping plate and the upright segment and which secure the sawhorse support assembly to the beam when the lower surface of the beam is supported by the beam support.

2. The sawhorse support assembly as defined in claim 1, wherein the first and second legs each have elongated shafts with upper ends that are connected to the beam connector and lower ends that are positioned away from the beam connector, the first and second legs defining an angle relative to one another such that the lower leg ends are spaced apart from one another at a distance that is larger than a distance between the upper leg ends, and wherein the clamping mechanism is configured so that selective movement moves the clamping plate through the range of positions from the upright segment without moving the legs relative to one another.

3. The sawhorse support assembly as defined in claim 1, wherein the clamping plate actuator is a linear actuator that moves the clamping plate in a linear motion by rotational movement of the linear actuator.

4. The sawhorse support assembly as defined in claim 1, wherein the clamping mechanism is configured to selectively move the clamping plate such that the beam is subject to compression between the clamping plate and the lower beam support, and between the clamping plate and the upright segment.

5. The sawhorse support assembly as defined in claim 1, wherein the range of selective movement of the clamping plate includes a position which allows a 1.5 inch thick beam to be placed between the clamping plate and the upright segment and a position which subjects the 1.5 inch thick beam to compression between the clamping plate and the upright segment.

6. The sawhorse support assembly as defined in claim 1, wherein the range of selective movement of the clamping plate includes a position which allows a 1.5 inch thick beam to be placed between the clamping plate and the upright segment and a position which subjects a 0.75 inch thick beam to compression between the clamping plate and the upright segment.

7. The sawhorse support assembly as defined in claim 1, wherein the range of selective movement of the clamping plate includes a position which allows a 0.75 inch thick beam to be placed between the clamping plate and the upright segment and a position which subjects the 0.75 inch thick beam to compression between the clamping plate and the upright segment.

8. The sawhorse support assembly as defined in claim 1, wherein the upright segment extends less than 3.5 inches from the lower beam support.

9. The sawhorse support assembly as defined in claim 1, wherein the clamping plate includes teeth which are configured to penetrate the side of the beam when the beam is subjected to compression.

10. The sawhorse support assembly as defined in claim 1, wherein the clamping mechanism includes more than one clamping plate actuator.

11. The sawhorse support assembly as defined in claim 10, wherein the clamping mechanism includes more than one clamping plate.

12. A method for manufacturing a sawhorse support assembly for connecting to a sawhorse beam to support one portion of the beam above a floor, the method comprising:
configuring a beam support for contacting a lower surface of the beam to resist movement of the beam toward the floor when the sawhorse support assembly is connected to the beam;
arranging first and second legs and connecting the legs to the beam support such that the beam support is positioned above the floor by the legs when the sawhorse support assembly is connected to the beam;
configuring an upright segment for contacting a first side surface of the beam; and
arranging a clamping mechanism for applying a compressive force to a second side surface of the beam, on an opposite side of the beam from the first side surface, to hold the beam between the clamping mechanism and the upright segment in a fixed position relative to the sawhorse support assembly when the beam connector is connected to the beam.

13. The method as defined in claim 12, further comprising:
configuring a clamping plate for movement relative to the upright segment and for contacting the second side surface to apply the compressive force to the beam; and
arranging a clamping plate actuator for moving the clamping plate and for generating the compressive force such that the compressive force is transferred through the clamping plate to the beam when the beam connector is connected to the beam.

14. The method as defined in claim 13, wherein the clamping plate is configured to include teeth to penetrate into the second side surface of the beam.

15. The method as defined in claim 13, wherein the clamping plate actuator is arranged to generate the compressive force in a direction that is partially toward the beam support.

16. The method as defined in claim 13, wherein the clamping plate actuator is arranged to include a head that is configured to provide leverage to rotate the clamping plate actuator about a longitudinal axis to generate the compressive force.

17. The method as defined in claim 13, wherein the clamping plate actuator is arranged for moving the clamping plate between an unclamped position, in which the beam can be inserted into the support assembly between the clamping plate and the upright segment to contact the beam support, and a clamped position in which the clamping plate applies the compressive force to the beam.

18. A sawhorse support assembly for operating in at least a pair to support a beam at a working height above a floor, the support assembly comprising:
first and second legs;
a beam support with an upper surface for contacting a lower surface of the beam and a lower surface, opposite to the upper surface, to which the first and second legs are connected;
an upright segment connected to the beam support such that an angle of at least approximately 90 degrees is defined in a corner between the upright segment and the upper surface of the beam support;
an actuator support connected to the beam support;
a clamping plate actuator connected to the actuator support and configured for selective movement relative to the actuator support; and
a clamping plate connected to the clamping plate actuator, and wherein the clamping plate actuator is configured to move the clamping plate through a range of positions relative to the upright segment, including at least one position which allows the beam to be placed between the clamping plate and the upright segment to contact the upper surface of the beam support, and at least one position which subjects the beam to compression when the beam is between the clamping plate and the upright segment and which secures the support assembly to the beam when the lower surface of the beam is in contact with the upper surface of the beam support.

19. The support assembly as defined in claim 18 wherein the clamping plate actuator is configured to move the clamping plate relatively farther from the upright segment and the beam support in the at least one position which allows the beam to be placed between the clamping plate and the upright segment, and relatively closer to the upright segment and the beam support in the at least one position which subjects the beam to compression.

20. The support assembly as defined in claim 18 wherein the clamping plate actuator is a linear actuator which includes a head that is configured to provide leverage to rotate the clamping plate actuator about a longitudinal axis to generate the compressive force.
